(19) United States
(12) Patent Application Publication
(10) Pub. No.: US 2018/0283170 A1
(43) Pub. Date: Oct. 4, 2018

(54) DOWNHOLE LOGGING SYSTEMS AND METHODS EMPLOYING ADJUSTABLY-SPACED MODULES

(71) Applicant: Halliburton Energy Services, Inc., Houston, TX (US)

(72) Inventors: Burkay Donderici, Houston, TX (US); Baris Guner, Kingwood, TX (US)

(73) Assignee: Halliburton Energy Services, Inc., Houston, TX (US)

(21) Appl. No.: 15/765,670

(22) PCT Filed: Nov. 6, 2015
(86) PCT No.: PCT/US15/59606

§ 371 Date: Apr. 3, 2018

(51) Int. Cl. E21B 47/12; G01V 1/46; G01V 3/26

(52) U.S. Cl. CPC E21B 47/122; G01V 1/46; G01V 1/226; E21B 47/124; G01V 3/26

(57) ABSTRACT

A downhole logging system includes a plurality of spaced modules that provide a distributed transmitter/receiver arrangement. The system also includes an inter-module spacing control tool that operates to change a spacing between a transmitter and at least one receiver of the distributed transmitter/receiver arrangement. A related downhole logging method includes deploying a plurality of spaced modules in a borehole, wherein the spaced modules provide a distributed transmitter/receiver arrangement. The method also includes changing a spacing between a transmitter and at least one receiver of the distributed transmitter/receiver arrangement. The method also includes performing logging operations based on the changed spacing between the transmitter and the at least one receiver of the distributed transmitter/receiver arrangement.

### BACKGROUND

During oil and gas exploration and production, many types of information are collected and analyzed. The information is used to determine the quantity and quality of hydrocarbons in a reservoir, and to develop or modify strategies for hydrocarbon production. Among the options available for collecting relevant information are logging-while-drilling (LWD) tools and logging tools deployed via wireline, slickline, or coiled tubing.

The resolution and/or depth of investigation of some logging tools (e.g., acoustic or resistivity loggings tools) depend at least in part on the spacing between transmitters and receivers. Previous options to collect logs for different transmitter/receiver arrangements involve a single logging tool with multiple transmitter/receiver arrangements or involve a tool string with multiple loggings tools. These options are expensive. Further, in deviated wells, deploying a single logging tool with multiple transmitter/receiver arrangements or deploying a tool string with multiple loggings tools increases the likelihood of the tool(s) becoming stuck (due to the tool or tool string length). With LWD tools, vibration, movement, and drill string criteria complicate obtaining or interpreting logging data.

### BRIEF DESCRIPTION OF THE DRAWINGS

Accordingly, there are disclosed herein downhole logging systems and methods employing adjustably-spaced modules along a connection line. In the drawings:

FIG. 1 is a block diagram showing an illustrative logging tool module.

FIG. 2 is a schematic diagram showing a logging tool with a plurality of spaced modules.

FIG. 3 is a schematic diagram showing the logging tool of FIG. 2 in a deviated well scenario.

FIGS. 4A and 4B are profiles of 1D formations.

FIGS. 5A and 5B are block diagrams of illustrative inversion processes to obtain resistivity values from logging data obtained using a plurality of spaced modules.

FIGS. 6A and 6B are block diagrams of illustrative system arrangements.

FIGS. 7A and 7B are diagrams showing an illustrative logging tool before and after a spacing adjustment and related logs.

FIG. 8 is a flowchart of an illustrative logging method.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are downhole logging systems and methods employing adjustably-spaced modules. In different embodiments, the adjustable-spaced modules are deployed along a connection line. The connection line may correspond to a wireline, a slickline, coiled tubing, a cable, or a combination of different options. Some connection line options are stiff while other connection line options are flexible (e.g., downhole spooling is possible). Further, different connection line options enable conveyance of power and/or communications between spaced modules or between a module and equipment at earth's surface. Electrical or optical conveyance of power and/or communications via connection lines is possible. In some embodiments, a connection line provides end-to-end coupling between adjacent modules. Alternatively, a connection line may pass through at least one module. To adjust the spacing between modules, an inter-module spacing control tool is employed. For example, one option to adjust the spacing between spaced modules involves a connection line crawler mechanism that moves a corresponding module along a connective line (i.e., a module's position along the connection line is adjusted). Another option to adjust the spacing between spaced modules involves a spooler mechanism that extends or retracts a connection line between adjacent modules (i.e., the extension length of a connection line between adjacent modules is adjusted). Such inter-module spacing control tool options may be integrated with one or more spaced modules of a logging tool or may be separate from the spaced modules of a logging tool.

In different embodiments, the spaced modules of a logging tool include, for example, at least one receiver or transmitter to provide a distributed transmitter/receiver arrangement related to a resistivity logging tool or acoustic logging tool. Thus, any adjustment to the spacing between spaced modules results in a different transmitter/receiver arrangement (at least the spacing is different). Further, in at least some embodiments, the azimuthal orientation of at least one receiver or transmitter included with a spaced module can be adjusted. In this manner, resistivity logging data or acoustic logging data can be collected using different transmitter/receiver arrangements (i.e., different spacings or orientations). Further, the inclination of one or more of the modules can be tracked and used to interpret resistivity logging data or acoustic logging data collected by a logging tool with adjustably-spaced modules as described herein. Without limitation to other embodiments, a logging tool with adjustably-spaced modules as described herein may also include spaced modules with a fixed spacing.

In at least some embodiments, an example downhole logging system includes a plurality of spaced modules that provide a distributed transmitter/receiver arrangement. The system also includes an inter-module spacing control tool that operates to change a spacing between a transmitter and at least one receiver of the distributed transmitter/receiver arrangement. Meanwhile, an example downhole logging method includes deploying a plurality of spaced modules in a borehole, wherein the spaced modules provide a distributed transmitter/receiver arrangement. The method also includes changing a spacing between a transmitter and at least one receiver of the distributed transmitter/receiver arrangement. The method also includes performing logging operations based on the changed spacing between the transmitter and the at least one receiver of the distributed transmitter/receiver arrangement. Various logging tool options, distributed transmitter/receiver options, inter-module spacing adjustment options, telemetry options, and other options are described herein.

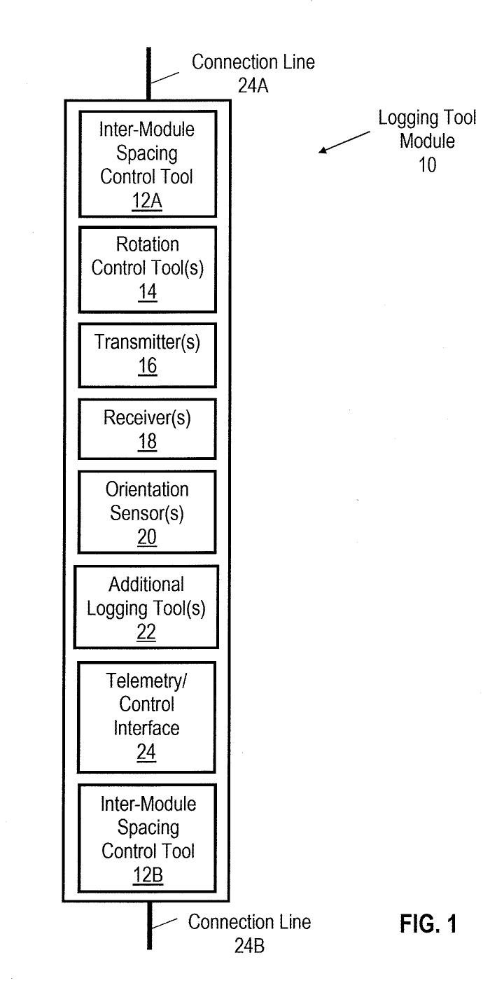

The disclosed methods and systems are best understood in an application context. Turning now to the figures, FIG. 1 is a block diagram showing an illustrative logging tool module 10. In FIG. 1, the module 10 is represented between connection lines 24A and 24B, which may correspond to a continuous line or separate lines. Each of the connection lines 24A and 24B may be a wireline, a slickline, coiled tubing, or a cable. In at least some embodiments, the module 10 includes inter-module spacing control tools 12A and 12B. For example, the inter-module spacing control tool 12A may operate to adjust the spacing between module 10 and at least one other module in the direction of connection line 24A, while the inter-module spacing control tool 12B may operate to adjust the spacing between module 10 and at least one other module in the direction of connection line 24B. In either case, the spacing adjustment changes a distributed transmitter/receiver arrangement involving a plurality of spaced modules such as module 10. The inter-module spacing control tools 12A and 12B may correspond to, for example, connection line crawler mechanisms or spooler mechanisms.

As an example, a crawler mechanism may include an anchoring component that holds or releases a connection line, and a crawl component that pushes or pulls the module 10 along a connection line while the anchoring component is in a release state. When a desired position is reached (or after a predetermined amount of time or movement), the anchoring component transitions to a hold state to maintain the position of the module 10 along a connection line. Meanwhile, a spooler mechanism may include a spool and a motor that causes the spool to rotate around an axis. Depending on the direction of spool rotation, a connection line is wrapped or unwrapped (shortening or extending the connection line between adjacent modules). In some embodiments, module 10 may omit one or both of the inter-module spacing control tools 12A and 12B (e.g., due to other modules including similar tools).

In FIG. 1, the module 10 also includes optional rotation control tool(s) 14, which may operate to cause the entire module 10 to rotate relative to the connection lines 24A or 24B or other modules. Alternatively, the rotation control tool(s) 14 may cause part of the module 10 to rotate relative to the connection lines 24A or 24B or other modules. In either case, transmitter(s) 16 and/or receiver(s) 18 of the module 10 may be rotated to adjust a distributed transmitter/receiver arrangement involving a plurality of spaced modules such as module 10.

In at least some embodiments, the module 10 also includes orientation sensor(s) 20 to track the module azimuth and/or inclination. If transmitter(s) 16 or receiver(s) 18 are associated with individually-rotatable sections of the module 10, the orientation sensor(s) 20 may track the azimuthal orientation of each such section or of select sections. The azimuthal orientation and/or inclination measurements collected by the orientation sensor(s) 20 can be used to interpret logging measurements obtained using a plurality of spaced modules corresponding to a distributed transmitter/receiver arrangement. In at least some embodiments, the module 10 also includes additional logging tool(s) 22. The additional logging tool(s) 22 are not part of the distributed transmitter/receiver arrangement, and may correspond to density logging tools, gamma ray logging tools, nuclear magnetic resonance (NMR) logging tools, borehole caliper tools or other known logging tools. As appropriate, the azimuthal orientation and/or inclination measurements collected by the orientation sensor(s) 20 can be used to interpret logging measurements obtained using the additional logging tool(s) 22. In some embodiments, module 10 may omit or vary the additional logging tool(s) 22.

In at least some embodiments, the module 10 also includes a telemetry/control interface 24 to direct logging operations, to store collected measurements, to process measurements, and/or to convey collected or processed measurements to another module and/or to earth's surface. In different embodiments, the telemetry/control interface 24 comprises one or more processors, memory, circuitry, and/or other electronics suitable for directing logging operations, storing collected measurements, processing measurements, and/or conveying collected or processed measurements to another module and/or to earth's surface. In at least some embodiments, the telemetry/control interface 24 includes one or more electro-optical transducers to convert electrical signals to optical signals or vice versa. Additionally or alternatively, the telemetry/control interface 24 includes one or more wireless telemetry interfaces. In different embodiments, the telemetry/control interface 24 may vary for different modules.

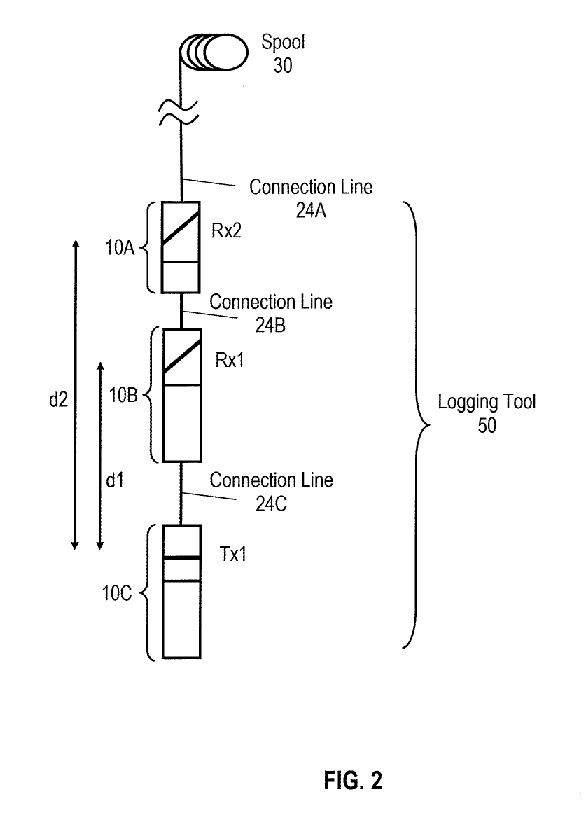

FIG. 2 is a schematic diagram showing a logging tool 50 with a plurality of spaced modules 10A, 10B, and 10C. In FIG. 2, a connection line 24A extends from spool 30 to module 10A, which is represented as the uppermost module of logging tool 50. The spool 30 may be located, for example, at earth's surface to control lowering and raising the logging tool 50. Meanwhile, connection line 24B extends between modules 10A and 10B, and connection line 24C extends between modules 10B and 10C. In FIG. 2, the connection lines 24A, 24B, and 24C may correspond to a continuous wireline, slick line, coiled tubing, or cable. Alternatively, the connection lines 24A, 24B, and 24C may correspond to a segmented connection line arrangement with at least two segments of wireline, slick line, coiled tubing, cable, or a combination thereof.

In FIG. 2, the modules 10A, 10B, and 10C of logging tool provide a distributed transmitter/receiver arrangement (i.e., not all transmitters/receivers are part of a single module). Specifically, module 10C is represented as having a co-axial transmitter (Tx1), module 10B is represented as having a first tilted receiver (Rx1), and module 10C is represented as having a second tilted receiver (Rx2). Without limitation, this distributed transmitter/receiver arrangement represented in FIG. 2 provides sensitivity to some cross-coupling components (in a resistivity logging embodiment). In different distributed transmitter/receiver arrangements, each transmitter may be horizontal, tilted or vertical. If there are multiple transmitters, one transmitter may be tilted while another is vertical (different orientations are possible for different transmitters). Similarly, each receiver may be horizontal, tilted, or vertical. If there are multiple receivers, one receiver may be tilted while another is vertical (different orientations are possible for different receiver). In different embodiments, the orientations of antennas or transducers corresponding to a distributed transmitter/receiver arrangement may vary. As desired, a multi-component design for all antennas, including both horizontal and vertical components, may be implemented to obtain a full set of cross components.

In FIG. 2, the distance or spacing between Tx1 and Rx1 is labeled d1, and the distance or spacing between Tx1 and Rx2 is labeled d2. In accordance with at least some embodiments, d1 and/or d2 is adjustable to support different distributed transmitter/receiver arrangements with logging tool 50. While not specifically represented in FIG. 2, the logging tool 50 may support adjusting and/or tracking the orientation of one or more of the modules 10A, 10B, and 10C. For example, due to twisting and turning of the connection lines 24A, 24B, 24C, as well as the change in the orientation of a well itself, the relative orientation of the modules 10A, 10B, and 10C may change over time and can be accounted for using sensors. Accordingly, the logging tool 50 may support tracking the orientation and/or inclination of one or more of the modules 10A, 10B, and 10C. The azimuthal orientation and inclination information can be used to interpret measurements collected by the distributed transmitter/receiver arrangement.

In at least some embodiments, an inclination measurement for a bottommost module (e.g., module 10C) of logging tool 50 is obtained and the inclination measurement is used to interpret acoustic logging or resistivity logging measurements obtained using the modules 10A, 10B, and 10C. Further, in some embodiments, an uppermost module (e.g., module 10A) of the logging tool 50 may direct telemetry or logging operations for all of the spaced modules 10A, 10B, and 10C. Further, in some embodiments, power or communications is conveyed between an uppermost module (e.g., module 10A) of the logging tool 50 and earth's surface using a wire or optical fiber. In such case, communications between the modules 10A, 10B, and 10C may be conveyed using wireless telemetry.

In at least some embodiments, the distances between transmitters and receivers may be dynamically changed by adjusting the extension length of the connection line between adjacent modules where transmitter and receiver antennas are located. As an example, such an adjustment can be accomplished using controlled or programmable mechanical components (e.g., crawler or spooler components) that lock or adjust the position of each module along a connection line. In at least some embodiments, dynamic spacing control between modules (e.g., modules 10A, 10B, and 10C) is provided based on predetermined instructions or feedback loops using a system controller or computer located downhole or at earth's surface. Further, a user may be able to monitor and intervene during logging operations to adjust the spacing of the modules using a user interface. Thus, adjustments to the spacing between modules may be automated and/or based on user input.

Such spacing adjustments can be used to vary the resolution and depths of investigation of a logging tool (e.g., logging tool 50). As a rule of thumb, it can be said that as the distance between the transmitter and receivers increases, the logging tool sees deeper into the formation and a high depth of investigation can be obtained while sacrificing resolution. One particular scenario where a high depth of investigation is desirable is the case where a distance-to-bed boundary is measured. However, designing a very long tool is difficult due to issues caused by the weight of the tool and transportation challenges. With the modular design described herein, a logging tool can be light weight and compact, yet easily expand to the desired size at the well site. As desired, the size of the logging tool may be adjusted to obtain a finer resolution in cases where bed boundaries are close.

In at least some embodiments, the logging tool 50 provides the following benefits: 1) dynamic spacing and face adjustment of antennas; 2) compensating distance changes due to tension of the cable; 3) running logs with different spacings to obtain different resolutions and depths of investigation; 4) a modular design that can be optimized for ranging applications; 5) azimuthal sensitivity by taking advantage of natural rotation of the wireline cable; 6) implementation of multi-component antennas easier than LWD tools (anisotropy measurements are possible); and 7) time domain applications may be performed more easily compared to the LWD tools. Further, the logging tool design represented in FIG. 2 allows a large separation between the transmitter and receivers. As the separation between transmitter and receiver increases, the obtained measurements correspond to regions deeper in the formation. Thus, the modular and adjustable design of logging tool 50 may be used to obtain very deep resistivity readings (e.g., to determine distance to bed boundaries).

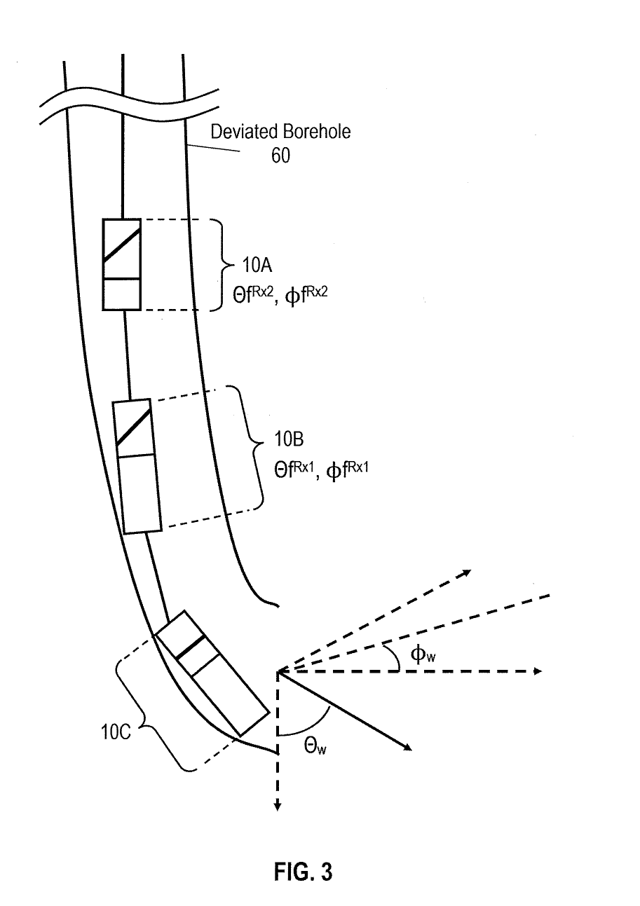

FIG. 3 is a schematic diagram showing the logging tool of FIG. 2 in a deviated well scenario. In FIG. 3, the modules 10A, 10B, and 10C are deployed along a deviated borehole 60. In at least some embodiments, the orientation between the modules 10A, 10B, and 10C may be measured via sensors tool included with each module. Furthermore, a mechanical assembly may be used to control the orientation of each module. This assembly may either be used to correct for any inadvertent orientation changes due to the rotation of a connection line as mentioned above, or to rotate a module for a specific purpose (e.g., changing an transmitter or receiver orientation to shift sensitivity to a particular formation region of interest). The “toolhead” of each module has an azimuth angle (Φ_{w}) and elevation angle (θ_{w}) with respect to true horizontal and vertical, respectively. It is assumed that, for the scenario of FIG. 3, the transmitter of module 10C has the same orientation with the toolhead, while the receiver (Rx1) of module 10B has an azimuthal shift of Φf^{Rx1} and an elevation angle shift of θf^{Rx1} with respect to the toolhead. Further, the receiver (Rx2) of module 10A has an azimuthal shift of Φf^{Rx2} and an elevation angle shift of θf^{Rx2} with respect to the toolhead.

In different scenarios, it may be desirable to adjust the orientation of logging tool transmitters or receivers to obtain additional information about a formation. For example, different transmitter-receiver arrangements may be used to increase sensitivity to bed boundaries, which may be useful for boundary detection. Alternatively, a particular transmitter-receiver arrangement may be used to decrease sensitivity to bed boundaries to obtain smoother data to be used in inversion. In at least some embodiments, dynamic orientation control for modules (e.g., modules 10A, 10B, and 10C) is provided based on predetermined instructions or feedback loops using a system controller or computer located downhole or at earth's surface. Further, a user may be able to monitor and intervene during logging operations to adjust the orientation of the modules using a user interface. Thus, adjustments to the orientation of one or more modules may be automated and/or based on user input.

In at least some embodiments, the data collected by a logging tool having a plurality of modules, where the spacing and orientation of the modules is dynamic, is inverted. As an example, data collected by a resistivity tool is inverted to obtain a value for the resistivity of the formation surrounding the tool. This inversion requires a forward model of tool's response for a given formation resistivity profile. The inversion process tries to find the formation profile whose modeled response best agrees with the values measured by the tool.

In most cases, a regularization is applied to obtain a smoother log. Although the inversion process is not the focus of this disclosure, it should be noted that accounting for the orientation and spacing information of the transmitters and receivers (or their corresponding modules) during the inversion process improves inversion accuracy.

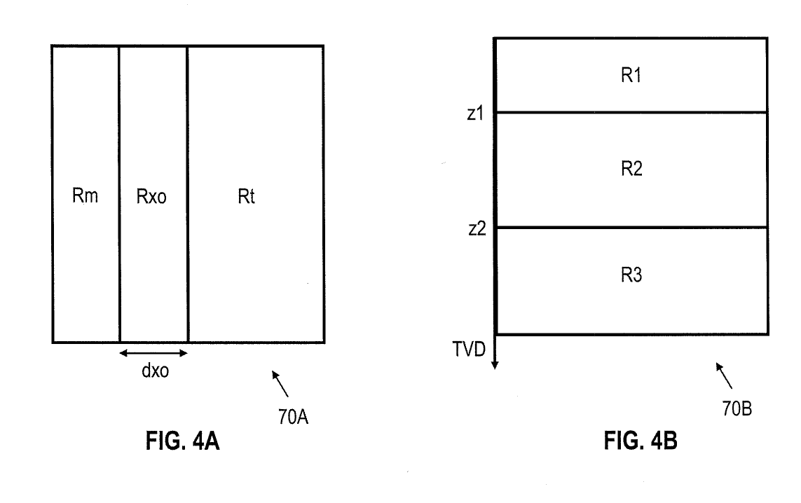

FIG. 4A is a radial profile 70A of a 1D formation with step invasion that may be employed in at least some embodiments. For the 1D formation represented by the radial profile 70A of FIG. 4A, inversion results include values for Rt (formation resistivity), Rxo (invasion resistivity), and dxo (invasion radius). Meanwhile, FIG. 4B is a vertical profile 70B of a 1D formation with three horizontal layers that may be employed in at least some embodiments. For the 1D formation represented by the vertical profile 70B of FIG. 4B, inversion results include resistivity values (R1, R2, R3) for each of three horizontal layers.

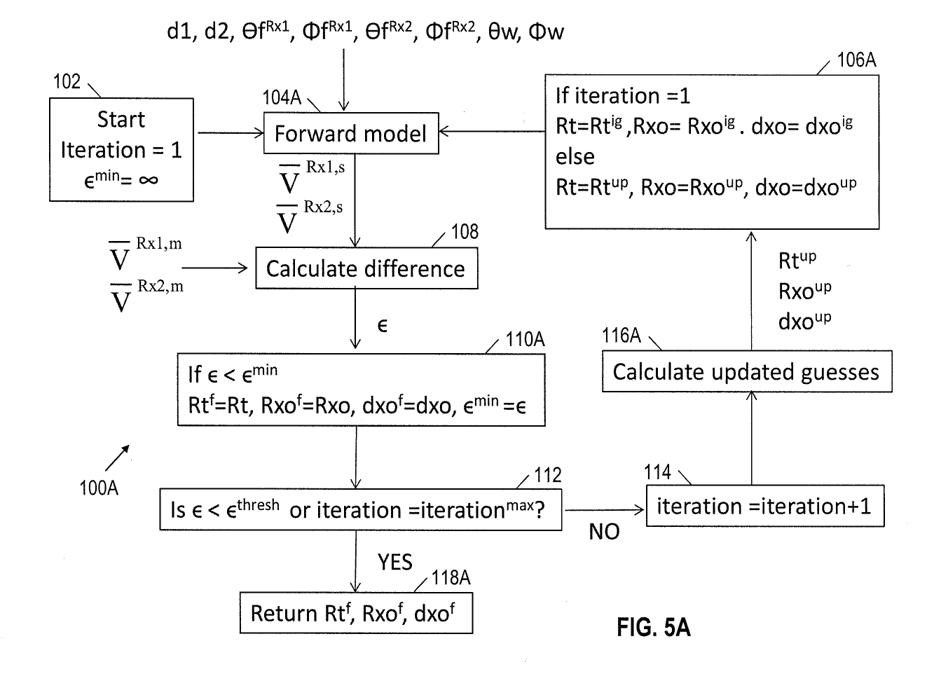

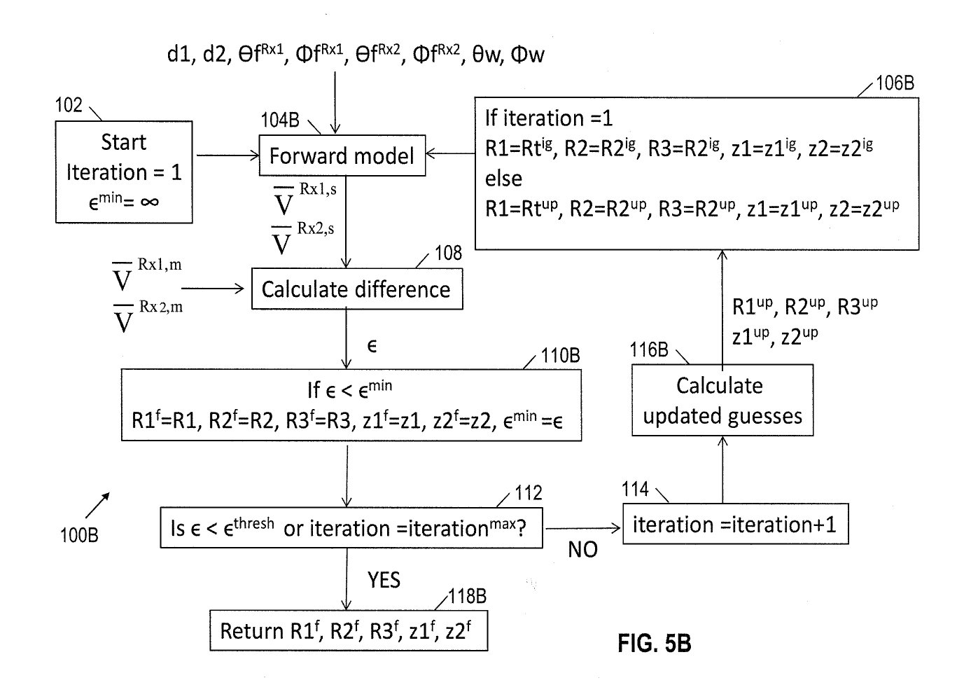

FIG. 5A is a block diagram of an illustrative inversion method 100A to obtain resistivity values from logging data obtained using a plurality of spaced modules. While the method 100A assumes a radial 1D formation profile (e.g., profile 70A of FIG. 4A), the method 100A is only an example and is not intended to limit the scope of the disclosure to resistivity logging tools or a particular inversion technique. As shown, method 100A includes a start block 102 and related block 106A, where the minimum error (ϵ^{min}) is set to infinity, the iteration is set to 1, and initial set of guesses for the formation parameters (Rt=Rt^{ig}, Rxo=Rxo^{ig}, dxo=dxo^{ig}) are provided. The forward model 104A receives the initial set of guesses for the formation parameters as well as tool properties (d1, d2, θf^{Rx1}, Φf^{Rx1}, θf^{Rx2}, Φf^{Rx2}, θw, Φw), and calculates the simulated voltages of each receiver (V^{Rx1,s}, V^{Rx2,s}). The norm of error between the measured receiver voltages and simulated voltages is the calculated (ϵ) at block 108. If this error is less than ϵ^{min}, ϵ^{min} is set to ϵ and answer products for the formation parameters used in the forward model 104A for that iteration are set (Rt^{f}=Rt, Rxo^{f}=Rxo, and dxo^{f}=dxo) at block 110A. At block 112, a check for convergence is performed by comparing ϵ with a threshold (ϵ^{thresh}). In order to prevent cases where convergence is not possible or takes a very long number of iterations, block 112 also involves comparing the iteration number with a maximum number of iterations (iteration^{max}) threshold. If one of these conditions is satisfied, inversion stops and returns values (Rt^{f}, Rxo^{f}, dxo^{f}) as answers at block 118A. Otherwise, the iteration count is increased by 1 at block 114, guesses for formation parameters (Rt^{up}, Rxo^{up}, dxo^{up}) are updated at block 116A, and the process is repeated. Different techniques exist to update the guesses such that the solution converges to a minimum. In at least some embodiments, conjugate-gradient based algorithms may be used for this purpose.

FIG. 5B is a block diagram of another illustrative inversion method 100B to obtain resistivity values from logging data obtained using a plurality of spaced modules. While the method 100B assumes a vertical 1D formation profile (e.g., profile 70B of FIG. 4B), the method 100B is only an example and is not intended to limit the scope of the disclosure to resistivity logging tools or a particular inversion technique. The method 100B is similar to the method 100A, except that the forward model 104B receives a set of initial guesses for different formation parameters (R1=Rt^{ig}, R2=R2^{ig}, R3=R2^{ig}, Z1=Z1^{ig}, Z2=Z2^{ig}) from block 106B. Further, if the error calculated by block 108 is less than ϵ^{min}, ϵ^{min} is set to ϵ and answer products for different formation parameters used in the forward model 104B for that iteration are set (R1^{f}=R1, R2^{f}=R2, R3^{f}=R3, Z1^{f}=Z1, Z2^{f}=Z2) at block 110B. Further, the answers returned at block 118B correspond to R1^{f}, R2^{f}, R3^{f}, z1^{f}, and z2^{f}, and the guesses for formation parameters updated at block 116B correspond to R1^{up}, R2^{up}, R3^{up}, z1^{up}, and z2^{up}.

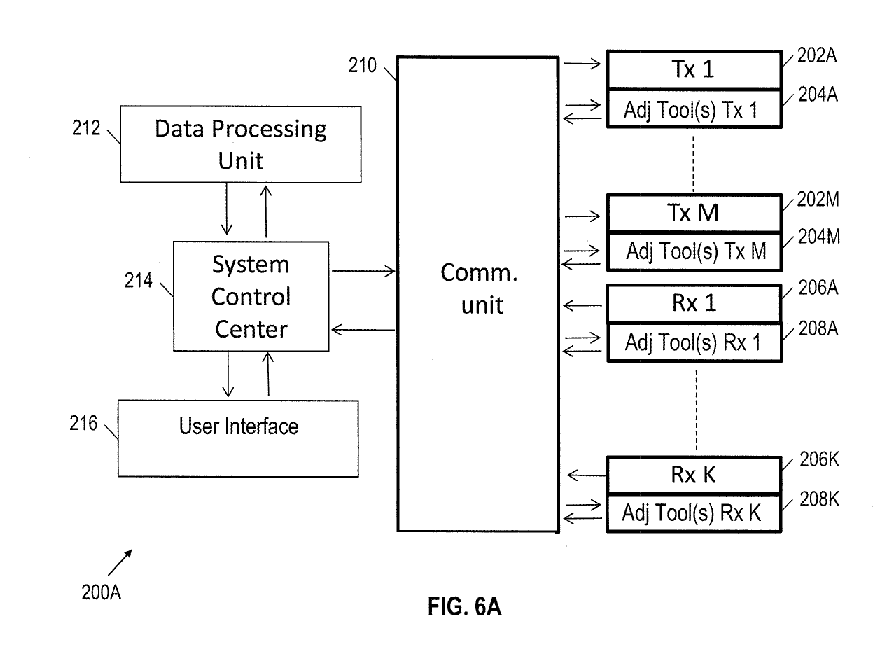

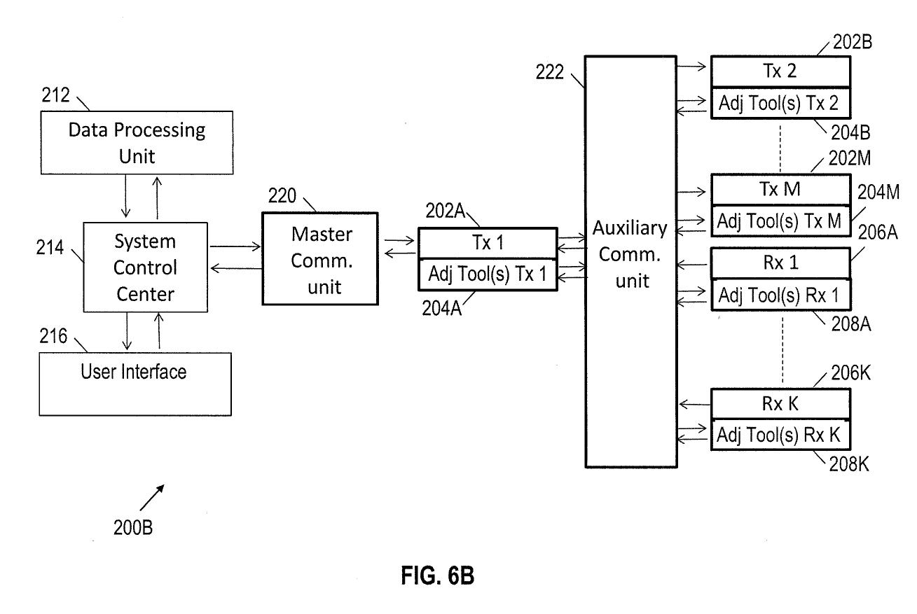

FIG. 6A and 6B are block diagrams of illustrative system arrangements 200A and 200B. In system arrangement 200A of FIG. 6A, transmitters 202A-202M (Tx1 through TxM) and receivers 206A-206K (Rx1 through RxK) are represented. Each transmitter may transmit an electromagnetic signal when a corresponding command from the system control center 214 arrives via the communications unit 210. The system control center 214 may also interact with adjustment tool(s) 204A-204M related to transmitters 202A-202M via the communications unit 210. For example, the adjustment tool(s) 204A-204M may operate to adjust the position of a respective transmitter and/or the orientation of a respective transmitter. Further, the adjustment tool(s) 204A-204M may include sensors to measure position, orientation, or inclination. In at least some embodiments, the adjustment tool(s) 204A-204M correspond to inter-spacing control tool(s) 12, rotation control tool(s) 14, and/or orientation sensors(s) 20 as described for the module 10 of FIG. 1.

In response to signals output by one or more of the transmitters 202A-202M, the receivers 206A-206K obtain measurements that are provided to the system control center 214 via the communications unit 210. The system control center 214 may also interact with the adjustments tool(s) 208A-208K for each of the receivers 206A-206K via the communications unit 210. For example, the adjustment tool(s) 208A-208K may operate to adjust the position of a respective receiver and/or the orientation of a respective receiver. Further, the adjustment tool(s) 208A-208K may include sensors to measure position, orientation, or inclination. In at least some embodiments, the adjustment tool(s) 208A-208K correspond to inter-spacing control tool(s) 12, rotation control tool(s) 14, and/or orientation sensors(s) 20 as described for the module 10 of FIG. 1.

Although the transmitters 202A-202M and the receivers 206A-206K are represented as being separate in FIGS. 6A and 6B, in some embodiments, a single transducer may be employed both as a transmitter and a receiver. As desired, each transmitter or receiver may operate at a select frequency or frequency range, or at multiple frequencies to increase the amount of information obtained from logging operations. Further, the adjustment tool(s) 204A-204M for transmitters 202A-202M and the adjustment tool(s) 208A-208K for receivers 206A-206K may be combined in different ways (e.g., modules may include more than one transmitter, more than one receiver, or a combination of transmitters and receivers). In at least some embodiments, each of the paired components (e.g., transmitter 202A and adjustment tool(s) 204A) correspond to a distinct module.

The measurements obtained from the receivers 206A-206K and/or information provided by the adjustments tool(s) 204A-204M and/or 208A-208K may be provided to a data processing unit 212 for analysis (e.g., to perform an inversion). The results of the analysis are stored and/or are provided to a user interface 216 to enable a user to make decisions related to drilling, well placement, well completion, and/or other hydrocarbon exploration or production issues. Further, the user interface 216 may enable a user to adjust measurements analysis options. Further, the user interface 216 may enable a user to select or adjust logging operations involving at least some of the transmitters 202A-202M, receivers 206A-206M, adjustment tool(s) 204A-204M, and/or adjustment tool(s) 208A-208K.

In the system arrangement 200B of FIG. 6B, many of the same components as those discussed for the system arrangement 200A of FIG. 6A are used and will not be described again. The difference between system arrangement 200B and system arrangement 200A is that system arrangement 200B employs a segmented communication configuration involving a master communication unit 220 and an auxiliary communication unit 222. As shown in FIG. 6B, a first transmitter 202A and related adjustment tool(s) 204A may communicate with system control center 214 via the master communication unit 220. Meanwhile, all other transmitters 202B-202M, adjustment tool(s) 204B-204M, receivers 206A-206K, and adjustment tool(s) 208A-204K may communicate with system control center 214 via the master communication unit 220 and the auxiliary communication unit 222. As an example, the system arrangement 200B may correspond to one module of logging tool 50 (e.g., module 10A) having a main controller or communication interface, while the other modules of logging tool (e.g., modules 10B and 10C) have auxiliary controllers or communication interfaces. In this example, the main module communicates with a system control center (e.g., at earth's surface) while the other modules communicate with the main module. As desired, the power and communication interface options between the main module and the system control center, and between the main module and the other modules may vary. Among the options available are wired or wireless power options, wired or wireless communication options, and optical or electrical interface options. Example telemetry options for a main module or the other modules include mud pulse, acoustic, or electromagnetic options. Example communication interfaces may couple to each other or to other components via conductive paths or optical paths with suitable transducers. As desired, inductive interfaces, galvanic interfaces, or capacitive interfaces may be employed by different modules to convey power or communications.

In at least some embodiments, the system control center 214 corresponds to a downhole component. For example, in a slickline or coiled tubing scenario, communication with earth's surface may not be available. Accordingly, a self-contained logging tool along a connection line may be employed. In such case, the logging tool may include a controller or computer that automates spacing adjustments, orientation adjustments, or other logging options without any communication with earth's surface.

Power distribution strategies may also vary in different embodiments. For example, in some embodiments, power may be distributed to each module individually and rectified separately. In other embodiments, power may be transmitted from earth's surface to one of the modules, where it is rectified and distributed to other modules. Remote power options (e.g., batteries) are also possible.

For different runs, logging tool assemblies may be changed, creating different levels of tension on the connection lines. Further, varying deviation of a well, natural movement and rotation of connections lines, or ambient temperature/pressure changes may all contribute to variations in module spacing and orientation (resulting in changes to the distributed transmitter/receiver arrangement). Accordingly, in at least some embodiments, the spacing and orientation of modules may be tracked and the tracked information may be used to interpret measurements obtained by a distributed transmitter/receiver arrangement. Corrections can be accounted for by processing techniques (e.g., during inversion), forward model selection (e.g., using a built-in look-up table for a specific tool spacing), or mechanical techniques (e.g., adjusting as needed to maintain a desired transmitter/receiver arrangement).

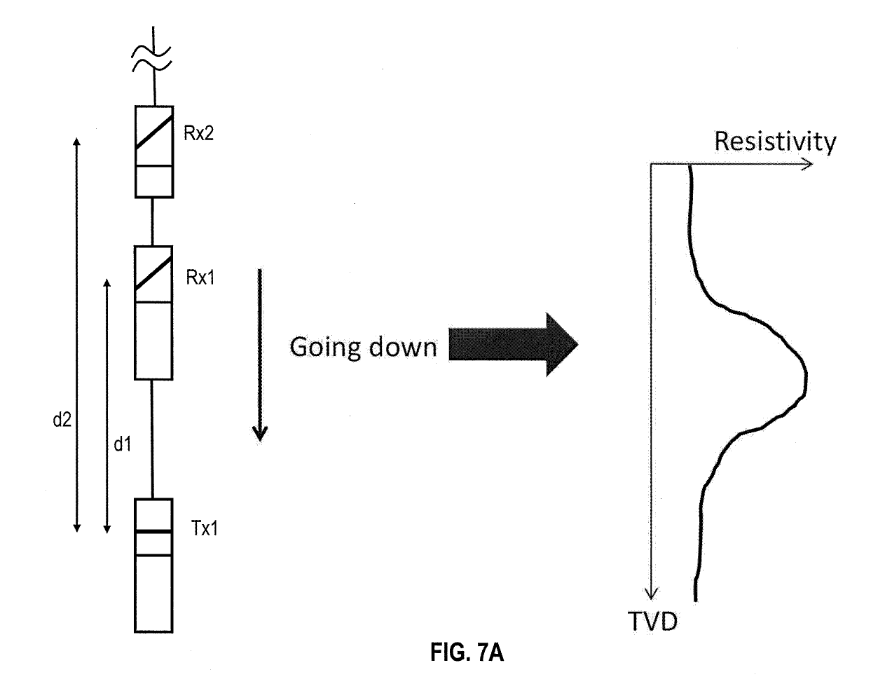

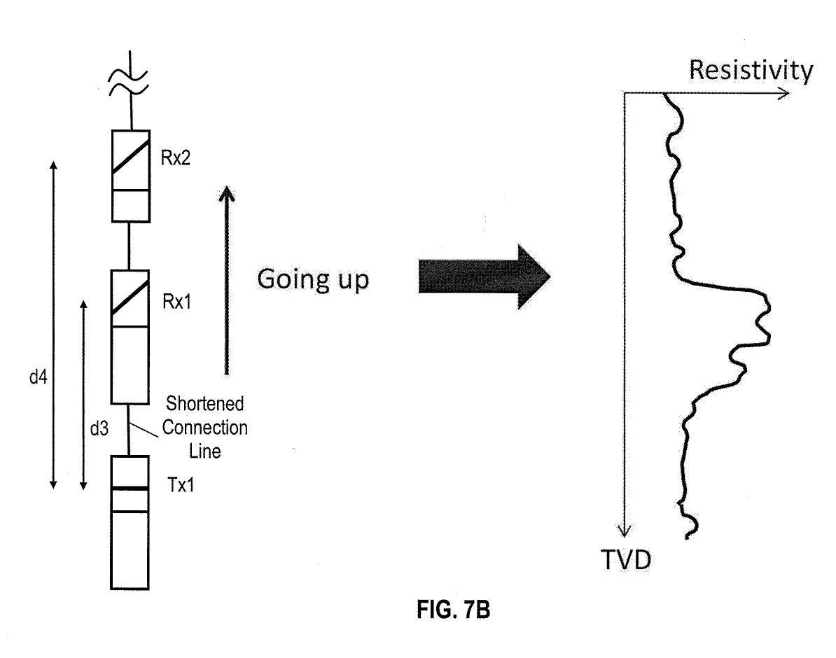

In at least some embodiments, the modular logging tool design described herein can be used to obtain logs with different spacings and thus different depths of investigation and vertical resolution from the same well using the same tool. As an example, the spacing may be varied between the down run (as the tool is moved deeper into the ground) and the up run (as the tool is pulled back to the surface). FIGS. 7A and 7B are diagrams showing an illustrative logging tool before and after a spacing adjustment and related logs. In FIG. 7A, an example logging tool obtains a log while proceeding downward (down-log) with spacings of d1 and d2 between the transmitter (Tx1) and the respective receivers Rx1 and Rx2. In this case, d1 and d2 are large (e.g., d1=50 ft, d2=100 ft). An example down-log is shown on the right of FIG. 7A. The represented down-log has coarse features since the vertical resolution of the logging tool of FIG. 7A is low, but includes responses from deeper into the formation.

Meanwhile, FIG. 7B shows an example logging tool that obtains a log while proceeding upwards (up-log) with spacings of d3 and d4 between the transmitter (Tx1) and the respective receivers Rx1 and Rx2, where d3 is smaller than d1 and d4 is smaller than d2 (see FIG. 7A). As an example, for spaced modules that provide only a distributed transmitter/receiver arrangement (no additional logging tools), d3 and d4 may be comparable to an array type tool with a single tool body (e.g., d3=2 ft, d4=5 ft). Meanwhile, for spaced modules that provide a distributed transmitter/receiver arrangement as well as additional logging tools, d3 and d4 may be larger due to one or more of the spaced modules being larger to accommodate additional logging tool components (e.g., d3=10 ft, d4=15 ft). In either case, the up-log of FIG. 7B has a higher vertical resolution and sharper features compared to the down-log of FIG. 7A. On the minus side, depth of investigation for the up-log of FIG. 7B would be lower than the down-log of FIG. 7A, thus the tool would be more affected by effects such as invasion. To adjust the logging tool from d1 and d2 as in FIG. 7A to d3 and d4 as in FIG. 7B, the connection line between the lower two modules is shortened. Alternatively, the position of lowermost module along a connection line may be adjusted. While FIGS. 7A and 7B show an up-log that is higher resolution than the down-log, it should be appreciated that spacings used to collects up-log and down-log may vary (e.g., the spacing between modules to obtain an up-log may be larger than the spacing between modules to obtain a down-log). Further, the same spacing between modules can be used to obtain both an up-log and a down-log. Further, due to the natural rotation of the tool string, spaced modules will likely pass through the same formation at two different rotation angles, which can provide additional information that can be used in the inversion process and improve accuracy of results.

With the logging options represented in FIGS. 7A and 7B, more information is obtained about a well compared to using a single logging tool. This information may be visually interpreted by a petrophysicist, or an algorithm may be devised to use the additional information to better invert formation and invasion properties. A similar application would involve rotating the antennas between different runs to obtain different cross-components which would also present additional information about the formation than what would be available with a traditional tool.

As mentioned before, the modular logging tool design described herein allows for obtaining very large spacings between tool's antennas in a relatively simple manner. This ability may be particularly beneficial in ranging type of applications. For example, to better survey any existing wells around a drilled well, a logging tool with a large spacing between modules may be used. The information obtained may be used later to select or update the path for a well to be drilled in a manner that prevents accidents or suboptimal well paths. Large spacings between modules of a logging tool may also be used to determine distance to bed boundaries and other formation properties deep into the formation.

Due to the natural rotation that may occur during logging operations (due to the twisting and turning of connection lines), this natural rotation may be leveraged to obtain azimuthally-sensitive measurements and thus improve distance-to-bed-boundary measurements. As desired, rotational measurements may be put into bins to increase directional sensitivity. Further, noise can be reduced by averaging measurements in the same bin. If possible (e.g., when logging tool components rotate at least 360°), a geosignal may be obtained.

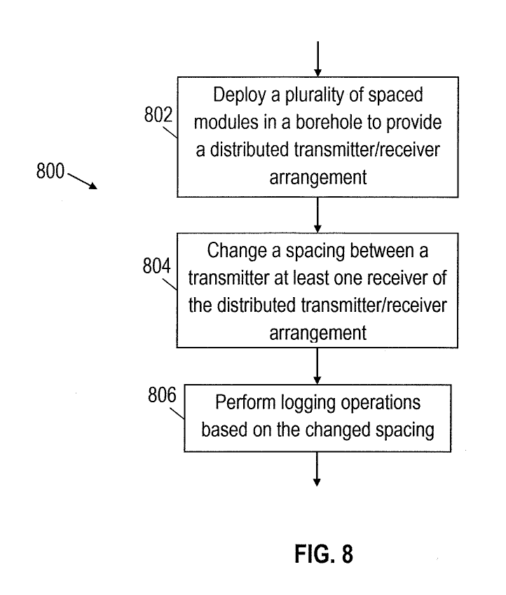

FIG. 8 is a flowchart of an illustrative logging method 800. In method 800, a plurality of spaced modules are deployed in a borehole to provide a distributed transmitter/receiver arrangement at block 802. At block 804, the spacing between a transmitter at least one receiver of the distributed transmitter/receiver arrangement is changed. In different embodiments, such a change is automated or programmed to enable logging operations at different spacings. Alternatively, the change may be in response to an operator making a selection via a user interface. Alternatively, the change may be in response to detecting that an existing spacing varies from a desired spacing. The mechanics of changing the spacing may involve a connection line crawler mechanism or a spooler mechanism. Without limitation, the connection line may correspond to a wireline, a slickline, a coiled tubing, or a cable. At block 806, logging operations are performed based on the changed spacing. Other options for method 800 include changing the orientation of one or more of the spaced modules. Further, orientation or inclination changes may be tracked and used to interpret obtained logging data (e.g., resistivity logging data or acoustic logging data). Further, the logging operations may result in logs or images that are displayed via a user interface. The displayed logs or images can be used to make decisions related to drilling, well placement, well completion, and/or other hydrocarbon exploration or production issues. Various module options, logging options, analysis options, inversion options, control options, communication options, and power options are available as described herein.

Embodiments disclosed herein include:

A: A downhole logging system that comprises a plurality of spaced modules that provide a distributed transmitter/receiver arrangement. The system also comprises an inter-module spacing control tool that operates to change a spacing between a transmitter and at least one receiver of the distributed transmitter/receiver arrangement.

B: A downhole logging method that comprises deploying a plurality of spaced modules in a borehole, wherein the spaced modules provide a distributed transmitter/receiver arrangement. The method also comprises changing a spacing between a transmitter and at least one receiver of the distributed transmitter/receiver arrangement. The method also comprises performing logging operations based on the changed spacing between the transmitter and the at least one receiver of the distributed transmitter/receiver arrangement.

Each of embodiments A and B may have one or more of the following additional elements in any combination: Element 1: further comprising a connection line between adjacent modules associated with the plurality of spaced modules, wherein the inter-module spacing control tool is configured to adjust the position of at least one of the plurality of spaced modules along the connection line. Element 2: further comprising a connection line between adjacent modules associated with the plurality of spaced modules, wherein the inter-module spacing control tool is configured to vary an extended length of the connection line to adjust the position of at least one of the plurality of spaced modules. Element 3: wherein the connection line corresponds to a wireline, a slickline, coiled tubing, or a cable. Element 4: wherein inter-module spacing control tool is integrated with at least one of the spaced modules. Element 5: wherein inter-module spacing control tool is separate from the spaced modules. Element 6: wherein the inter-module spacing control tool comprises a connection line crawler mechanism. Element 7: wherein the inter-module spacing control tool comprises a spooler mechanism. Element 8: wherein at least one of the spaced modules comprises a rotation control tool to change an azimuthal orientation of at least one transmitter or receiver. Element 9: wherein at least one of the spaced modules comprises an orientation sensor, and wherein an azimuthal orientation measurement obtained by the orientation sensor is used to interpret acoustic logging or resistivity logging measurements obtained using the spaced modules. Element 10: wherein a lowermost module of the spaced modules comprises an orientation sensor, and wherein an inclination measurement obtained by the orientation sensor is used to interpret acoustic logging or resistivity logging measurements obtained using the spaced modules. Element 11: wherein an uppermost module of the spaced modules comprises a control or telemetry interface to direct telemetry or logging operations for all of the spaced modules. Element 12: further comprising a wire or optical fiber between an uppermost module of the spaced modules and earth's surface, and wherein the spaced modules communicate to each other using wireless telemetry interfaces. Element 13: wherein the distributed transmitter/receiver arrangement is used to collect acoustic logging or resistivity logging measurements as a function of position using different spacings between a transmitter and at least one receiver of the distributed transmitter/receiver arrangement.

Element 14: wherein the spacing between the transmitter and at least one received is changed by adjusting the position of at least one of the plurality of spaced modules along a connection line. Element 15: wherein the spacing between the transmitter and at least one received is changed by adjusting the length of a connection line. Element 16: wherein the connection line corresponds to a wireline, a slickline, coiled tubing, or a cable. Element 17: further comprising changing an azimuthal orientation of at least one transmitter or receiver associated with the distributed transmitter/receiver arrangement. Element 18: further comprising obtaining an azimuthal orientation measurement for at least one of the spaced modules and using the azimuthal orientation measurement interpret acoustic logging or resistivity logging measurements obtained using the spaced modules. Element 19: further comprising obtaining an inclination measurement for a bottommost module of the spaced modules and using the inclination measurement to interpret acoustic logging or resistivity logging measurements obtained using the spaced modules. Element 20: further comprising using an uppermost module of the spaced modules to direct telemetry or logging operations for all of the spaced modules. Element 21: further comprising conveying power or communications between an uppermost module of the spaced modules and earth's surface using a wire or optical fiber, and conveying communications between the spaced modules using wireless telemetry. Element 22: further comprising collecting acoustic logging or resistivity logging measurements as a function of position using different spacings between a transmitter and at least one receiver of the distributed transmitter/receiver arrangement.

Numerous variations and modifications will become apparent to those skilled in the art once the above disclosure is fully appreciated. It is intended that the following claims be interpreted to embrace all such variations and modifications.

What is claimed is:

1. A downhole logging system that comprises:
a plurality of spaced modules that provide a distributed transmitter/receiver arrangement; and
an inter-module spacing control tool that operates to change a spacing between a transmitter and at least one receiver of the distributed transmitter/receiver arrangement.

2. The system of claim 1, further comprising a connection line between adjacent modules associated with the plurality of spaced modules, wherein the inter-module spacing control tool is configured to adjust the position of at least one of the plurality of spaced modules along the connection line.

3. The system of claim 1, further comprising a connection line between adjacent modules associated with the plurality of spaced modules, wherein the inter-module spacing control tool is configured to vary an extended length of the connection line to adjust the position of at least one of the plurality of spaced modules.

4. The system according to any one of claims 2 and 3, wherein the connection line corresponds to a wireline, a slickline, coiled tubing, or a cable.

5. The system of claim 1, wherein inter-module spacing control tool is integrated with at least one of the spaced modules.

6. The system of claim 1, wherein inter-module spacing control tool is separate from the spaced modules.

7. The system of claim 1, wherein the inter-module spacing control tool comprises a connection line crawler mechanism.

8. The system of claim 1, wherein the inter-module spacing control tool comprises a spooler mechanism.

9. The system of claim 1, wherein at least one of the spaced modules comprises a rotation control tool to change an azimuthal orientation of at least one transmitter or receiver.

10. The system of claim 1, wherein at least one of the spaced modules comprises an orientation sensor, and wherein an azimuthal orientation measurement obtained by the orientation sensor is used to interpret acoustic logging or resistivity logging measurements obtained using the spaced modules.

11. The system of claim 1, wherein a lowermost module of the spaced modules comprises an orientation sensor, and wherein an inclination measurement obtained by the orientation sensor is used to interpret acoustic logging or resistivity logging measurements obtained using the spaced modules.

12. The system of claim 1, wherein an uppermost module of the spaced modules comprises a control or telemetry interface to direct telemetry or logging operations for all of the spaced modules.

13. The system of claim 1, further comprising a wire or optical fiber between an uppermost module of the spaced modules and earth's surface, and wherein the spaced modules communicate to each other using wireless telemetry interfaces.

14. The system of claim 1, wherein the distributed transmitter/receiver arrangement is used to collect acoustic logging or resistivity logging measurements as a function of position using different spacings between a transmitter and at least one receiver of the distributed transmitter/receiver arrangement.

15. A downhole logging method that comprises:
deploying a plurality of spaced modules in a borehole, wherein the spaced modules provide a distributed transmitter/receiver arrangement;
changing a spacing between a transmitter and at least one receiver of the distributed transmitter/receiver arrangement; and
performing logging operations based on the changed spacing between the transmitter and the at least one receiver of the distributed transmitter/receiver arrangement.

16. The method of claim 15, wherein the spacing between the transmitter and at least one received is changed by adjusting the position of at least one of the plurality of spaced modules along a connection line.

17. The method of claim 15, wherein the spacing between the transmitter and at least one received is changed by adjusting the length of a connection line.

18. The method according to any one of claims 16 and 17, wherein the connection line corresponds to a wireline, a slickline, a coiled tubing, or a cable.

19. The method of claim 15, further comprising changing an azimuthal orientation of at least one transmitter or receiver associated with the distributed transmitter/receiver arrangement.

20. The method of claim 15, further comprising obtaining an azimuthal orientation measurement for at least one of the spaced modules and using the azimuthal orientation measurement interpret acoustic logging or resistivity logging measurements obtained using the spaced modules.

21. The method of claim 15, further comprising obtaining an inclination measurement for a bottommost module of the spaced modules and using the inclination measurement to interpret acoustic logging or resistivity logging measurements obtained using the spaced modules.

22. The method of claim 15, further comprising using an uppermost module of the spaced modules to direct telemetry or logging operations for all of the spaced modules.

23. The method of claim 15, further comprising conveying power or communications between an uppermost module of the spaced modules and earth's surface using a wire or optical fiber, and conveying communications between the spaced modules using wireless telemetry.

24. The method of claim 15, further comprising collecting acoustic logging or resistivity logging measurements as a function of position using different spacings between a transmitter and at least one receiver of the distributed transmitter/receiver arrangement.
